(19) United States
(12) Patent Application Publication
(10) Pub. No.: US 2020/0391757 A1
(43) Pub. Date: Dec. 17, 2020

(54) AUTONOMOUS DRIVE CONTROL APPARATUS, VEHICLE HAVING THE SAME, AND METHOD FOR CONTROLLING THE VEHICLE

(71) Applicants: Hyundai Motor Company, Seoul (KR); Kia Motors Corporation, Seoul (KR)

(72) Inventors: Donghyuk Kim, Hwaseong-si (KR); Seunghyun Kim, Seoul (KR); Ilhwan Kim, Hwaseong-si (KR); Hong Gi Park, Seoul (KR); Kyung-joo Bang, Seoul (KR)

(21) Appl. No.: 16/667,567

(22) Filed: Oct. 29, 2019

(30) Foreign Application Priority Data
Jun. 11, 2019 (KR) 10-2019-0068579

(51) Int. Cl. B60W 50/038; G05D 1/00; B60W 30/18; B60W 50/08

(52) U.S. Cl. CPC B60W 50/038; G05D 1/0088; B60W 2050/0072; B60W 50/08; G05D 2201/0213; B60W 30/18

(57) ABSTRACT

A vehicle includes a communication device configured to receive current position information; a plurality of devices for recognizing an obstacle; a storage for storing strategy information corresponding to a failure of each of the plurality of devices; and an autonomous drive control apparatus configured to diagnose a failure of the plurality of devices during autonomous driving, when at least one device fails, identify strategy information corresponding to the at least one device stored in the storage, and perform restriction control on at least one of a driving speed, a lane change, or a backward movement of the autonomous driving based on the strategy information, wherein the plurality of devices includes a plurality of image obtainers, a first distance detector including a plurality of radars, and a second distance detector including a plurality of LiDARs.

### CROSS-REFERENCE TO RELATED APPLICATION(S)

The present application claims the benefit of priority to Korean Patent Application No. 10-2019-0068579, filed on Jun. 11, 2019 in the Korean Intellectual Property Office, the entire disclosure of which is incorporated herein by reference.

### TECHNICAL FIELD

The present disclosure relates to an autonomous drive control apparatus, a vehicle having the autonomous drive control apparatus, and a method for controlling the vehicle, for improving stability of autonomous driving.

### BACKGROUND

A vehicle is a machine that drives on a road by driving wheels. The vehicle is equipped with various devices for passenger protection, driver assistance and a comfortable ride.

In recent years, studies have been actively conducted on an autonomous drive control apparatus that automatically recognizes a road environment, determines a driving situation, and controls driving of the vehicle according to a planned route so as to automatically drive the vehicle to a destination.

The autonomous drive control apparatus recognizes a change in obstacle and lanes and generates a route for collision-avoidance driving in real time. In this case, it is important to determine possible collisions with surrounding stationary or moving obstacles in order to perform the autonomous driving more stably on an actual road.

The autonomous drive control apparatus predicts presence and behavior of surrounding obstacles of the vehicle by using various sensors provided in the vehicle during the autonomous drive control, and reflects the predicted existence and behavior of the surrounding obstacles in autonomous driving. In this case, if the existence and behavior of the surrounding obstacle cannot be predicted due to the failure in at least one sensor or the like, and thus the existence and behavior of the surrounding obstacles cannot be reflected in the autonomous driving control, the autonomous drive control apparatus makes the driving of the vehicle unstable and causes an collision accident with the obstacles.

The information included in this Background section is only for enhancement of understanding of the general background of the present disclosure and may not be taken as an acknowledgement or any form of suggestion that this information forms the prior art already known to a person skilled in the art.

### SUMMARY

According to one aspect of the disclosure, an autonomous drive control apparatus can diagnose failure of a plurality of devices for autonomous driving, identify a movement restriction area corresponding to a recognition area of a device diagnosed with a failure, and control autonomous driving based on strategy information corresponding to the identified movement restriction area. A vehicle having such an autonomous drive control apparatus and a method for controlling the vehicle are also disclosed herein.

According to another aspect of the disclosure, an autonomous drive control apparatus can search for a service center for repairing a device diagnosed with a failure based on current position information of the vehicle and getting off information of the passengers when a failure of at least one device is diagnosed, and control a guidance to the searched service center. A vehicle having such an autonomous drive control apparatus and a method for controlling the vehicle are also disclosed herein.

In accordance with one aspect of the disclosure, an autonomous drive control apparatus may comprise: a communication device configured to perform communication with an external device and a plurality of devices for obstacle recognition, and to receive current position information; a storage storing strategy information corresponding to a failure of each of the plurality of devices; and a controller configured to diagnose a failure of the plurality of devices during autonomous driving, when at least one device among the plurality of devices fails, to identify the strategy information corresponding to the at least one device stored in the storage, and to perform restriction control on at least one of a driving speed, a lane change, or a backward movement of the autonomous driving based on the identified strategy information.

The controller may be further configured to search for a service center for repairing the at least one device based on the current position information received through the communication device, to control the autonomous driving to the service center as a destination, and to transmit a service request to the service center.

When searching for the service center, the controller may be further configured to obtain route information based on reception of information about getting-off of a person on board through the communication device, and to search for the service center based on the route information.

The storage may further store information about a movement restriction area of a vehicle corresponding to the failure of each of the plurality of devices.

The controller may be further configured to change a driving mode to a manual driving mode when the movement restriction area corresponding to the at least one device is at least one of a front long distance area or a front short distance area of the vehicle.

The controller may be further configured to determine whether a type of a road is an expressway based on the received current position information. When the type of the road is the expressway and when the movement restriction area corresponding to the at least one device is at least one of a front long distance area, a right side area, or a left side area, the controller may restrict the driving speed or the lane change.

When the movement restriction area corresponding to the at least one device is the front long distance area, the controller may restrict the driving speed. When the movement restriction area corresponding to the at least one device is at least one of the right side area or the left side area, the controller may restrict the lane change.

The controller may be further configured to determine whether a type of a road is a city road based on the received current position information. When the type of the road is the city road and when the movement restricting region corresponding to the at least one device is at least one of a front left side area, a front right side area, a rear left side area, or a rear right side area, the controller may control autonomous driving for a forward and backward movement, and control the lane change based on manipulation information of a steering wheel received from a user.

In accordance with another aspect of the disclosure, a vehicle comprising: a communication device configured to receive current position information; a plurality of devices for recognizing an obstacle; a storage for storing strategy information corresponding to a failure of each of the plurality of devices; and an autonomous drive control apparatus configured to diagnose a failure of the plurality of devices during autonomous driving, when at least one device among the plurality of devices fails, to identify the strategy information corresponding to the at least one device stored in the storage, and to perform restriction control on at least one of a driving speed, a lane change, or a backward movement of the autonomous driving based on the identified strategy information, wherein the plurality of devices includes a plurality of image obtainers, a first distance detector including a plurality of radars, and a second distance detector including a plurality of LiDARs.

The autonomous drive control apparatus may be further configured to search for a service center for repairing the at least one device based on the received current position information, to control the autonomous driving to the searched service center as a destination, and to transmit a service request to the service center.

The vehicle may further include: an input for receiving information about whether a person on board will get off, wherein, when searching for the service center, the autonomous drive control apparatus may be further configured to obtain route information based on the information about whether a person on board will get off received through the input, and to search for a service center based on the route information.

The storage may further store information about a movement restriction area of the vehicle corresponding to the failure of each of the plurality of devices. The movement restriction area may further include a front long distance area, a front short distance area, a front right side area, a front left side area, a right side area, a left side area, a rear right side area, a rear left side area, a rear long distance area, and a rear short distance area.

The autonomous drive control apparatus may be further configured to change a driving mode to a manual driving mode when the movement restriction area corresponding to the at least one device is at least one of the front long distance area or the front short distance area of the vehicle.

The autonomous drive control apparatus may further determine whether a type of a road is an expressway based on the received current position information. When the type of the road is the expressway and when the movement restriction area corresponding to the at least one device is at least one of the front long distance area, the right side area, or the left side area, the autonomous drive control apparatus restricts the driving speed or the lane change.

When the movement restriction area corresponding to the at least one device is the front long distance area, the autonomous drive control apparatus restricts the driving speed. When the movement restriction area corresponding to the at least one device is at least one of the right side area and the left side area, the autonomous drive control apparatus restricts the lane change.

The autonomous drive control apparatus may be further configured to determine whether a type of a road is a city road based on the received current position information. When the type of the road is the city road and when the movement restriction area corresponding to the at least one device is at least one of the front left side area, the front right side area, the rear left side area, or the rear right side area, the autonomous drive control apparatus controls autonomous driving for a forward and backward movement, and controls the lane change based on manipulation information of a steering wheel received from a user.

The vehicle may further include: a display for displaying information corresponding to the restriction control.

In accordance with another aspect of the disclosure, a control method of a vehicle may comprise: searching for a route based on current position information received by a communication device and destination information input through an input, performing autonomous driving based on the route, diagnosing a failure of a plurality of devices to recognize an obstacle during the autonomous driving, identifying strategy information corresponding to at least one device among the plurality of devices determined to have a failure, and controlling at least one of a driving speed, a lane change, or a backward movement of the autonomous driving based on the strategy information.

The control method may further include: searching for a service center for repairing the at least one device based on the current position information and the route, and transmitting a service request to the service center.

The searching for a service center may include, when information about getting-off of a person on board is received, obtaining route information based on the information about getting-off of the person on board. The searching for a service center may further include searching for the service center based on the route information.

The control method may further include: changing a driving mode to a manual driving mode, when the strategy information corresponding to the at least one device indicates that driving at a speed higher than a first predetermined driving speed is prevented or that driving at a speed lower than a second predetermined driving speed is prevented.

The control method may further include: determining whether a type of a road is an expressway based on the current position information, and determining whether the strategy information corresponding to the at least one device indicates that driving at a speed higher than a first predetermined driving speed or that lane change is prevented, when the type of the road is the expressway.

The control method may further include: determining whether a type of a road is a city road based on the current position information, determining whether or not the strategy information corresponding to the at least one device indicates that lane change needs to be performed manually, when the type of the road is the city road.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is an external view a vehicle, a passenger vehicle, according to an exemplary embodiment of the disclosure;

FIG. 2 is an external view of a vehicle, a truck, according to an exemplary embodiment of the disclosure;

FIGS. 3A, 3B and 3C illustrate recognition areas of devices equipped in the truck shown in FIG. 2;

FIG. 4 illustrates a movable area of a vehicle, e.g., a truck, according to an exemplary embodiment of the disclosure;

FIG. 5. illustrates information about a movement restriction area of a vehicle, e.g., a truck, for each failed device stored in the truck, according to an exemplary embodiment of the disclosure;

FIG. 6. illustrates strategic information for each movement restriction area of a vehicle, e.g., a truck, which is stored in the truck, according to an exemplary embodiment of the disclosure;

FIG. 7 is a control block diagram of a vehicle, e.g., a truck, according to an exemplary embodiment of the disclosure; and

FIGS. 8A and 8B are flowcharts illustrating an example of a control method of a vehicle, e.g., a truck, according to an exemplary embodiment of the disclosure.

### DETAILED DESCRIPTION

In the following description, like reference numerals refer to like elements throughout the specification. Well-known functions or constructions are not described in detail since they would obscure the one or more exemplar embodiments with unnecessary detail.

Terms such as “unit,” “module,” and “device” may be embodied as hardware or software. According to embodiments, a plurality of “units,” “modules,” and “devices” may be implemented as a single component or a single “unit,” “module,” and “device” may include a plurality of components.

It will be understood that when an element is referred to as being “connected” to another element, it can be directly or indirectly connected to the other element, wherein the indirect connection includes connection via a wireless communication network.

Also, when a part “includes” or “comprises” an element, unless there is a particular description contrary thereto, the part may further include other elements, not excluding the other elements.

It will be understood that, although the terms first, second, etc. may be used herein to describe various elements, these elements should not be limited by these terms. These terms are only used to distinguish one element from another. As used herein, the term “and/or” includes any and all combinations of one or more of the associated listed items.

As used herein, the singular forms “a,” “an” and “the” are intended to include the plural forms as well, unless the context clearly indicates otherwise.

An identification code is used for the convenience of the description but is not intended to illustrate the order of each step. Each of the steps may be implemented in an order different from the illustrated order unless the context clearly indicates otherwise.

Reference will now be made in detail to embodiments of the disclosure, examples of which are illustrated in the accompanying drawings.

Vehicles are classified into a passenger vehicle for personal use and for the purpose of transport, and a commercial vehicle for commercial use and for the purpose of transporting goods or humans.

Examples of the commercial vehicle are a truck, a dump truck, a van, a forklift truck, a special-purpose vehicle, and a bus and taxi for the purpose of transporting the humans.

A trailer having no power source may travel on the road while being connected to the rear portion of the vehicle and towed by the vehicle.

The trailer is designed to transport humans or goods and may be detachably connected to the vehicle.

Examples of a trailer that may be connected to the passenger vehicle are a caravan and a mini cargo trailer, and examples of a trailer that may be connected to a truck are a full trailer, a trolley, a bus full trailer, and a semi-trailer.

The vehicle according to one aspect of the present disclosure is an autonomous vehicle and includes an autonomous drive control apparatus. The autonomous vehicle includes various devices for detecting and recognizing an obstacle around the vehicle for autonomous driving. The number and installation positions of the various devices may vary depending on the type and size of the vehicle, and recognition areas for recognizing obstacles by the devices may be different from one another.

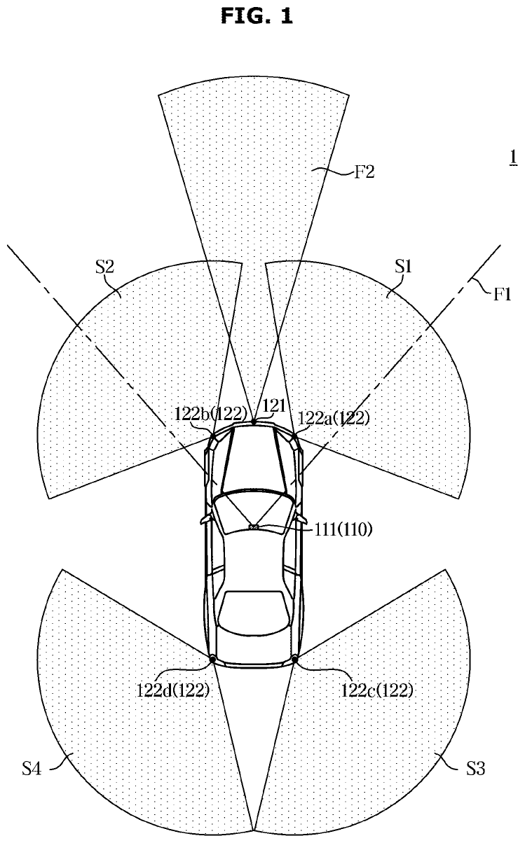

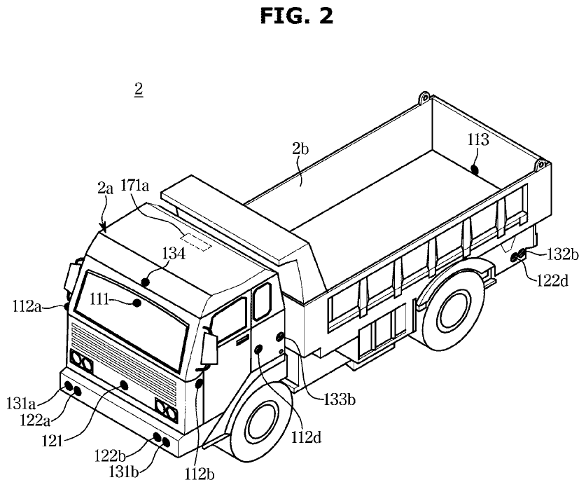

This will be described with reference to FIGS. 1 and 2.

FIG. 1 is an external view illustrating a vehicle, a passenger vehicle, according to an exemplary embodiment.

A passenger vehicle 1 includes an image obtainer 110 to secure a field of view toward the front of the vehicle 1, and an obstacle detector 120 to detect an obstacle in front, behind, on the left or right of the vehicle 1, i.e., in a recognition area of the obstacle, and recognize a distance to the detected obstacle.

The image obtainer 110 may include a front camera 111 installed on a front windshield glass of the vehicle 1.

The front camera 111 may obtain an image in a recognition area F1 corresponding to a forward field of view.

The front camera 111 may photograph the front of the vehicle 1, and obtain image data of the front of the vehicle 1. The image data of the front of the vehicle 1 includes positional information about at least one of another vehicle, a pedestrian, a cyclist, a lane, a curb, a guardrail, a street tree, and a street lamp located in front of the vehicle 1.

The front camera 111 includes a plurality of lenses and an image sensor. The image sensor may include a plurality of photodiodes that convert light into electrical signals, and the plurality of photodiodes are arranged in a two-dimensional matrix.

The front camera 111 may send the image data of the front of the vehicle to a controller.

The distance detector 120 may include a front radar 121, and a plurality of corner radars 122.

The front radar 121 has a field of view directed to the front of the vehicle 1, and detects an obstacle in a recognition area F2 corresponding to the field of view.

The front radar 121 may be installed in a grille or a bumper of the vehicle 1

The front radar 121 may include a transmission antenna (or a transmission antenna array) that radiates a transmission radio wave to the front of the vehicle 1 and a reception antenna (or a reception antenna array) that receives reflected radio waves reflected from an obstacle.

The front radar 121 may obtain forward radar data from the transmission radio wave transmitted by the transmission antenna and the reflection radio wave received by the reception antenna.

The forward radar data may include position information and speed information about other vehicles, pedestrians or cyclists located in front of the vehicle 1.

The front radar 121 may calculate a relative distance to the obstacle based on a phase difference (or time difference) between the transmission radio wave and the reflection radio wave, and calculate a relative speed of the obstacle based on a frequency difference between the transmission radio wave and the reflection radio wave.

The plurality of corner radars 122 includes a first corner radar 122a installed on a front right side of the vehicle 1, a second corner radar 122b installed on a front left side of the vehicle 1, a third corner radar 122c installed on a rear right side of the vehicle 1, and a fourth corner radar 122d installed on a rear left side of the vehicle 1.

The first corner radar 122a may include a field of view directed to the front right side of the vehicle 1, and may detect obstacles in a recognition area S1 corresponding to the field of view. The first corner radar 122a may be installed on a right side of a front bumper of the vehicle 1.

The second corner radar 122b may include a field of view directed to the front left side of the vehicle 1, and may detect obstacles in a recognition area S2 corresponding to the field of view. The second corner radar 122b may be installed on a left side of the front bumper of the vehicle 1.

The third corner radar 122c may include a field of view directed to the rear right of the vehicle 1, and may detect obstacles in a recognition area S3 corresponding to the field of view. The third corner radar 122c may be installed on a right side of a rear bumper of the vehicle 1.

The fourth corner radar 122d may have a field of view directed to the rear left side of the vehicle 1 and may detect obstacles in a recognition zone S4 corresponding to the field of view, and may be installed on a left side of the rear bumper of the vehicle 1.

Each of the first, second, third and fourth corner radars 122a, 122b, 122c, and 122d may include a transmit antenna and a receive antenna.

The first, second, third and fourth corner radars 122a, 122b, 122c and 122d may obtain first, second, third, and fourth corner radar data, respectively.

The first corner radar data may include distance information and speed information about other vehicles, pedestrians or cyclists (hereinafter referred to as “obstacles”) located on the front right side of the vehicle.

The second corner radar data may include distance information and speed information of obstacles located on the front left side of the vehicle.

The third and fourth corner radar data may include distance information and speed information of obstacles located at the rear right side and the rear left side of the vehicle, respectively.

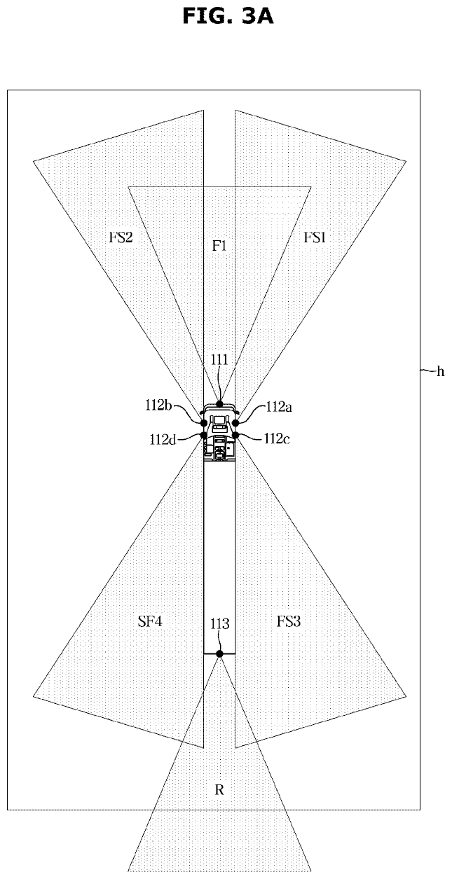

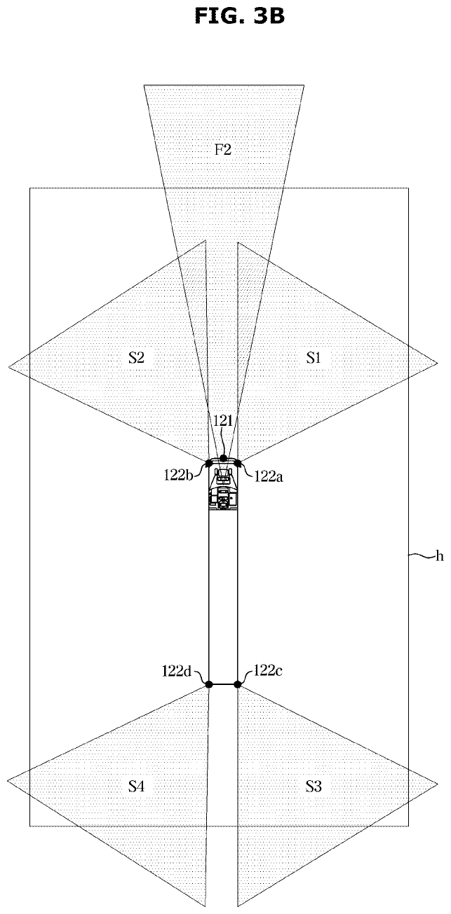

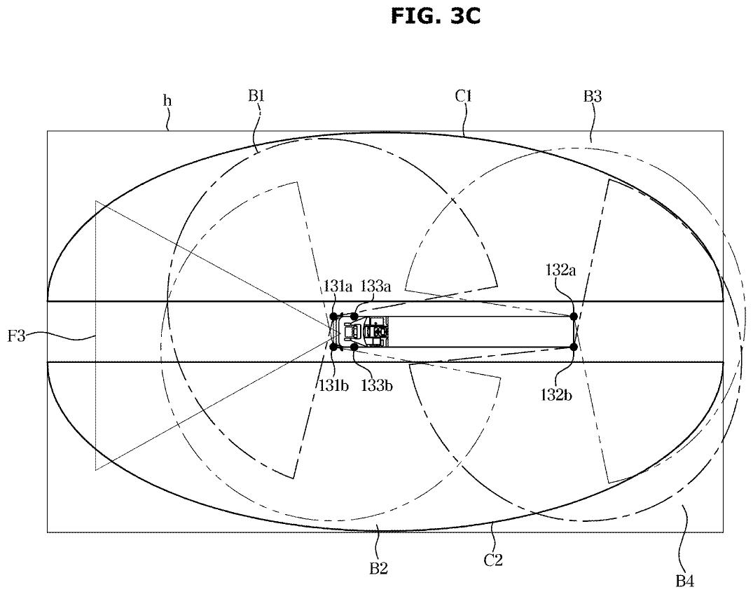

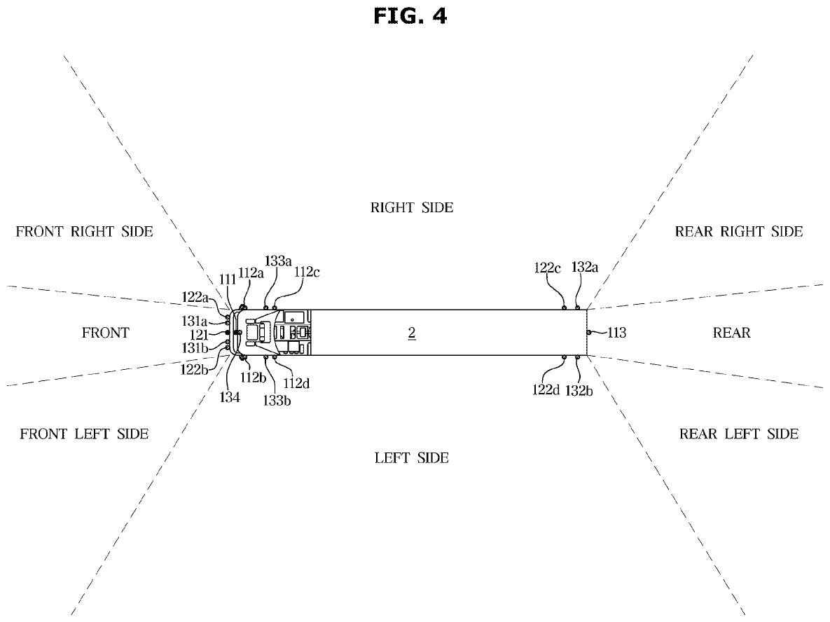

FIG. 2 is an external view illustrating a vehicle, a truck, according to an exemplary embodiment of the disclosure. FIGS. 3A, 3B and 3C illustrate recognition areas of devices equipped in the truck shown in FIG. 2. FIG. 4 illustrates a recognition area of the truck shown in FIG. 2.

A truck 2 may be a machine that drives on a road by driving wheels in order to transport goods. The truck 2 may include a tractor 2a having power, and a trailer 2b detachably connected to the tractor 2a to carry goods.

The tractor 2a may draw the trailer 2b, and include a body having an interior and an exterior, and a chassis which is the remaining portion except for the body and in which mechanical devices required for driving are installed.

The exterior of the body may include a hood, left and right doors installed in a front portion of the body, window glasses, and a plurality of west coast mirrors to provide a user with a rear view of the truck 2.

The trailer 2b may be loaded with various kinds of goods. Goods loaded in the trailer 2b may include humans as well as things.

The trailer 2b may be moved by power of the tractor 2a to transport goods loaded therein.

The interior of the truck 2 may include a seat on which a passenger sits, a dashboard, an instrument panel (i.e., a cluster), a center fascia, a head unit, an input, and a display.

The chassis of the truck 2 may further include driving apparatuses for applying driving force and braking force to the front, rear, left, and right wheels, such as a power generating apparatus, a power transfer apparatus, a steering apparatus, a braking apparatus, a suspension apparatus, and a transmission apparatus.

The truck 2 may include an accelerator pedal that is pressed by a user according to the user's acceleration intention, a brake pedal that is pressed by the user according to the user's braking intention, and a steering wheel of the steering apparatus for enabling the user to change a driving direction.

Hereinafter, the same components between the passenger vehicle 1 and the vehicle 2, i.e., the truck 2 will have the same reference numerals.

The truck 2 includes an image obtainer 110 to secure a field of view to the front, left side, right side and rear of the vehicle 2, and first and second distance detectors 120 and 130 provided at front, left side, right side and rear of the exterior of the vehicle 2, for detecting an obstacle in front, back, left or right side of the vehicle 2, i.e., in a recognition region of obstacles and recognizing a distance to the detected obstacle.

The image obtainer 110 may include a front camera 111, a plurality of side cameras 112, and a rear camera 113.

The front camera 111 may be installed in the front windshield glass of the vehicle 2.

The front camera 111 may photograph the front of the vehicle 2 and may obtain image data of the front of the vehicle 2. The image data at the front of the vehicle 2 may include positional information about at least one of other vehicles, pedestrians, cyclists, lanes, curbs, guardrails, street trees, and street lamps located in front of the vehicle.

The plurality of side cameras 112 (112a, 112b, 112c, and 112d) are provided at doors on the left and right sides of the tractor 2a and includes first and second side cameras having forward shooting direction, and third and fourth side cameras having backward shooting directions.

The first and second side cameras 112a and 112b photograph front left and front right sides of the vehicle 2, and the third and fourth side cameras 112c and 112d photograph rear left and rear right sides of the vehicle 2. The first and second side cameras 112a and 112b obtain image data of the front left side and the front right side of the vehicle 2. The third and fourth side cameras 112c and 112d obtain image data of the rear left side and the rear right side of the vehicle 2. The image data of the front left side and the front right side and the image data of the rear left side and the rear right side may include position information regarding at least one of other vehicles, pedestrians, cyclists, lanes, curbs, guardrails, roadside trees, and street lights located in the left and right directions in front of the vehicle and in the left and right directions behind the vehicle.

The rear camera 113 may be installed at the rear of the trailer 2b of the vehicle 2.

The rear camera 113 may photograph the rear area from the vehicle 2 and obtain image data of the rear area from the vehicle 2. The image data of the rear area from the vehicle 2 may include position information regarding at least one of other vehicles, pedestrians, cyclists, lanes, curbs, guard rails, roadside trees, and street lights located behind the vehicle.

As shown in FIG. 3A, the front camera 111 may obtain an image in a recognition area F1 corresponding to the field of view of the front camera 111, the first side camera 112a may obtain an image in a recognition area FS1 corresponding to the field of view of the first side camera 112a, the second side camera 112b may obtain an image in a recognition area FS2 corresponding to the field of view of the second side camera 112b, the third side camera 112c may obtain an image in a recognition area FS3 corresponding to the field of view of the third side camera 112c, the fourth side camera 112d may obtain an image in a recognition area FS4 corresponding to the field of view of the fourth side camera 112d, and the rear camera 113 may obtain an image in a recognition area R1 corresponding to the field of view of the rear camera 113.

Each camera of the image obtainer 110 may include a plurality of lenses and an image sensor. The image sensor may include a plurality of photodiodes for converting light into an electrical signal, and the plurality of photodiodes may be arranged in a two-dimensional matrix.

Each camera of the image obtainer 110 may be electrically connected to a controller 172. For example, each camera may be connected to the controller 172 through a vehicle communication network (NT), connected to the controller 172 through a hard wire, or connected to the controller 172 through a printed circuit board (PCB).

Each camera may transmit the image data in the corresponding direction to the controller 172.

The first and second distance detectors 120 and 130 are devices with different obstacle detection methods. For example, the first distance detector 120 may include a radar (Radio Detecting And Ranging), and the second distance detector 130 may include a LiDAR (Light Detection And Ranging).

The radar may include a transmit antenna (or transmit antenna array) that emits transmit radio waves and a receive antenna (or receive antenna array) that receives reflected radio waves reflected from obstacles.

The radar is a device to detect the position of an obstacle by using a reflected wave resulting from radiation of radio waves when transmitting and receiving are performed at the same place.

The radar may use the Doppler effect, change the frequency of the transmission radio waves over time, or output pulse waves as transmission radio waves in order to prevent overlapping of transmitted and received radio waves.

The LiDAR is a non-contact distance detection sensor using the laser radar principle.

The LiDAR may include a transmitter for transmitting laser and a receiver for receiving laser reflected from a surface of an obstacle present in the field of view.

The LiDAR has higher accuracy in a transverse sensitivity than the radar, thereby increasing the accuracy of a process of determining whether there is a passage ahead.

The first distance detector 120 may include a front radar 121 and a plurality of corner radars 122.

The front radar 121 may have a field of view toward the front of the vehicle 2, and may detect an obstacle in the recognition area F2 corresponding to the field of view.

The front radar 121 may be installed on the front of the tractor 2a.

The front radar 121 may obtain front radar data from the transmitted radio wave transmitted by the transmit antenna and the reflected radio wave received by the receive antenna.

The front radar data may include position information and speed information about other vehicles, pedestrians or cyclists located in front of the vehicle.

The front radar 121 calculates the relative distance to the obstacle based on the phase difference (or time difference) between the transmission wave and the reflection wave, and calculates the relative speed of the obstacle based on the frequency difference between the transmission wave and the reflection wave.

The front radar 121 may be connected to the controller 172 through, for example, a vehicle communication network NT, hard wire or a printed circuit board. The front radar 121 may transmit the front radar data to the controller 172.

The plurality of corner radars 122 includes a first corner radar 122a provided on the front right side of the vehicle, a second corner radar 122b provided on the front left side of the vehicle, a third corner radar 122c provided on the rear right side of the vehicle, and a fourth corner radar 122d provided on the rear left side of the vehicle.

The first corner radar 122a may have a field of view toward the front right side of the vehicle, may detect an obstacle in the recognition area S1 corresponding to the field of view, and may be installed at the right side of the front side of the tractor 2a.

The second corner radar 122b may have a field of view toward the front left side of the vehicle, may detect an obstacle in the recognition area S2 corresponding to the field of view, and may be installed at the left side of the front side of the tractor 2a.

The third corner radar 122c may have a field of view toward the rear right side of the vehicle, may detect an obstacle in the recognition area S2 corresponding to the field of view, and may be installed at the right side of the rear side of the trailer 2b.

The fourth corner radar 122d may have a field of view toward the rear left side of the vehicle, may detect an obstacle in the recognition area S2 corresponding to the field of view, and may be installed at the left side of the rear side of the trailer 2b.

The first, second, third and fourth corner radars 122a, 122b, 122c, and 122d may obtain first corner radar data, second corner radar data, third corner radar data, and fourth corner radar data, respectively.

The first corner radar data may include distance information and speed information about other vehicles, pedestrians or cyclists (hereinafter referred to as an “obstacle”) located at the right side of the front of the vehicle.

The second corner radar data may include distance information and speed information of an obstacle located at the left side of the front of the vehicle.

The third and fourth corner radar data may include distance information and speed information of the obstacle located at the right side and the left side of the rear of the vehicle, respectively.

Each of the first, second, third and fourth corner radars 122a, 122b, 122c, 122d may be connected to the controller 172 through the vehicle communication network NT, hard wire or a printed circuit board. The first, second, third and fourth corner radars 122a, 122b, 122c, and 122d may transmit the first, second, third, and fourth corner radar data to the controller, respectively. The controller 172 may be a controller provided in the vehicle 2 or may be a controller of the autonomous drive control apparatus 170.

As shown in FIG. 3B, the front radar 121 may obtain obstacle information in the recognition area F2 corresponding to the field of view of the front radar 121, and the first corner radar 122a may obtain obstacle information in the recognition area S1 corresponding to the field of view of the first corner radar 122a, the second corner radar 122b may obtain obstacle information in the recognition area S2 corresponding to the field of view of the second corner radar 122b, the third corner radar 122c may obtain obstacle information in the recognition area S3 corresponding to the field of view of the third corner radar 122c, and the fourth corner radar 122d may obtain obstacle information in the recognition area S4 corresponding to the field of view of the fourth corner radar 122d.

The obstacle information is information obtained from the corner radar data, and may include existence information of the obstacle, distance and speed information of the obstacle and direction information of the obstacle.

The second distance detector 130 may include first and second front LiDARs 131a and 131b, first and second rear LiDARs 132a and 132b, and first and second side LiDARs 133a and 133b. The second distance detector 130 may further include a third front LiDAR 134.

The third front LiDAR 134 may be a high resolution LiDAR having higher resolution h than that of the first and second front LiDARs 131a and 131b, the first and second rear LiDARs 132a and 132b, and the first and second side LiDARs 133a and 133b.

In a direct pulse method, the LiDAR transmits single pulse laser and then measures time for which the laser is reflected and returns from an obstacle to obtain distance information on a relative distance to the obstacle.

In a continuous wave method, the LiDAR transmits laser that is continuously modulated at a specific frequency, and then measures an amount of phase change of the laser signal reflected from an obstacle to obtain time and distance information on the relative distance to the obstacle.

The first front LiDAR 131a may have a field of view toward the front and right side of the vehicle 2, and may detect an obstacle in a recognition area B1 corresponding to the field of view.

The first front LiDAR 131a may be installed at the right side of the front of the tractor 2a.

The first front LiDAR 131a may obtain laser data of the front right direction based on the transmission laser transmitted by the transmitter and the reception laser received by the receiver.

The laser data of the front right direction may include distance information about the obstacle located in the front right direction of the vehicle, and may further include speed information.

The second front LiDAR 131b may have a field of view toward the front and the left side of the vehicle 2, and may detect an obstacle in a recognition area B2 corresponding to the field of view.

The second front LiDAR 131b may be installed at the front left side of the tractor 2a.

The second front LiDAR 131b may obtain laser data of the front left direction based on the transmission laser transmitted by the transmitter and the reception laser received by the receiver.

The laser data of the front left direction may include distance information regarding the obstacle located in the front left direction of the vehicle, and may further include speed information.

The first rear LiDAR 132a may have a field of view toward the rear and right side of the vehicle 2, and may detect an obstacle in a recognition area B3 corresponding to the field of view.

The first rear LiDAR 132a may be installed at the rear right side of the trailer 2b.

The first rear LiDAR 132a may obtain laser data of the rear right direction based on the transmission laser transmitted by the transmitter and the reception laser received by the receiver.

The laser data of the rear right direction may include distance information about the obstacle located in the rear and right direction of the vehicle, and may further include speed information.

The second rear LiDAR 132b may have a field of view toward the rear and left of the vehicle 2, and may detect an obstacle in a recognition area B4 corresponding to the field of view.

The second rear LiDAR 132b may be installed at the rear left side of the trailer 2b.

The second rear LiDAR 132b may obtain laser data of the rear left direction based on the transmission laser transmitted by the transmitter and the reception laser received by the receiver.

The laser data of the rear left direction may include distance information about the obstacle located in the rear and left direction of the vehicle 2, and may further include speed information.

The first side LiDAR 133a may have a field of view toward the right side of the vehicle 2, and may detect an obstacle in a recognition area C1 corresponding to the field of view.

The first side LiDAR 133a may be installed at the right side of a side surface of the tractor 2a.

The first side LiDAR 133a may obtain laser data of a right direction based on the transmission laser transmitted by the transmitter and the reception laser received by the receiver.

The laser data of the right direction may include distance information about the obstacle located in the right direction of the vehicle, and may further include speed information.

The second side LiDAR 133b may have a field of view toward the left side of the vehicle 2, and may detect an obstacle in a recognition area C2 corresponding to the field of view.

The second side LiDAR 133b may be installed at the left side of the side surface of the tractor 2a. The side surface of the tractor may be a position adjacent to the door.

The second side LiDAR 133b may obtain laser data of a left direction based on the transmission laser transmitted by the transmitter and the reception laser received by the receiver.

The laser data of the left direction may include distance information about the obstacle located in the left direction of the vehicle 2, and may further include speed information.

The third front LiDAR 134 may have a field of view toward the front of the vehicle 2, and may detect an obstacle in a recognition area F3 corresponding to the field of view.

The field of view of the third front LiDAR 134 may be narrower than the field of view of the front radar 121. That is, the front distance detectable by the third front LiDAR 134 may be shorter than the front distance detectable by the front radar 121.

The third front LiDAR 134 may be installed on the roof panel of the tractor 2a or in an upper portion of the front windshield glass.

The third front LiDAR 134 may obtain front laser data based on the transmission laser transmitted by the transmitter and the reception laser received by the receiver.

The laser data of the front of the vehicle may include distance information about an obstacle located in front of the vehicle, and may further include speed information.

As shown in FIG. 3C, the first front LiDAR 131a may obtain obstacle information in the recognition area B1 corresponding to the field of view of the first front LiDAR 131a, the second front LiDAR 131b may obtain obstacle information in the recognition area B2 corresponding to the field of view of the second front LiDAR 131b, the first rear LiDAR 132a may obtain obstacle information in the recognition area B3 corresponding to field of view of the first rear LiDAR 132a, and the second rear LiDAR 132b may obtain obstacle information in the recognition area B4 corresponding to the field of view of the second rear LiDAR 132b.

The first side LiDAR 133a may obtain obstacle information in the recognition area C1 corresponding to the sensing field of view of the first side LiDAR 133a, the second side LiDAR 133b may obtain obstacle information in the recognition area C2 corresponding to the field of view of the LiDAR 132b, and the third front LiDAR 134 may obtain obstacle information in the recognition area F3 corresponding to the field of view of the third front LiDAR 134.

The obstacle information is obtained from the laser data, and may include existence information of an obstacle, distance and speed information of the obstacle, and direction information of the obstacle.

In addition, boxes h in FIGS. 3A, 3B, and 3C are displayed for comparison of distances of the respective recognition areas.

As shown in FIG. 4, the vehicle 2 recognizes an obstacle in front of the vehicle 2 using at least one of the front radar 121, the front camera 111, and the third front LiDAR 134. The recognizing the obstacle may include obtaining obstacle information.

The front radar 121 recognizes an obstacle at a long distance in front of the vehicle 2, and the front camera 111 and the third front LiDAR 134 recognize an obstacle at a short distance in front of the vehicle.

That is, the front radar 121 may recognize an obstacle in front of the vehicle 2, which is farther away than the front camera 111 and the third front LiDAR 134 may recognize.

The front of the vehicle 2 may be a center in a direction in which the vehicle 2 moves forward.

The vehicle 2 may recognize an obstacle in the front right direction (i.e., on the front right side) of the vehicle 2 by using at least one of the first front LiDAR 131a, the first side camera 112a, and the first corner radar 122a

The vehicle 2 may recognize an obstacle in the front left direction (i.e., the on the front left side) by using at least one of the second front LiDAR 131b, the second side camera 112b, and the second corner radar 122b.

The vehicle 2 may recognize an obstacle in the right direction (i.e., on the right side) of the vehicle 2 by using at least one of the third side camera 112c and the first side LiDAR 133a.

The vehicle 2 may recognize an obstacle in the left direction (i.e., on the left side) of the vehicle 2 using at least one of the fourth side camera 112d and the second side LiDAR 133b.

The vehicle 2 may recognize an obstacle in the rear right direction (i.e., on the rear right side) of the vehicle 2 using at least one of the third corner radar 122c and the first rear LiDAR 132a.

The vehicle 2 may recognize an obstacle in the rear left direction (i.e., on the rear left side) of the vehicle using at least one of the fourth corner radar 122d and the second rear LiDAR 132b.

The vehicle 2 may recognize an obstacle in the rear direction of (i.e., behind) the vehicle 2 by using at least one of the third corner radar 122c, the fourth corner radar 122d, and the rear camera 113.

The rear camera 113 may recognizes an obstacle at a short distance behind the vehicle 2, and the third corner radar 122c and the fourth corner radar 122d may recognize an obstacle at a long distance behind the vehicle 2.

That is, the third corner radar 122c and the fourth corner radar 122d may recognize obstacles behind the vehicle, which is farther away from the vehicle 2 than the rear camera 113 may recognize.

Here, areas in the front, front left, front right, right, left, rear right, rear left and rear directions are movable areas to which the vehicle 2 may move in relation to the obstacle information recognized by each device of the vehicle.

When recognizing an obstacle in each movable area during autonomous driving control, a device used for the obstacle recognition is determined. Information about each device used for obstacle recognition in a movable area is stored in the vehicle.

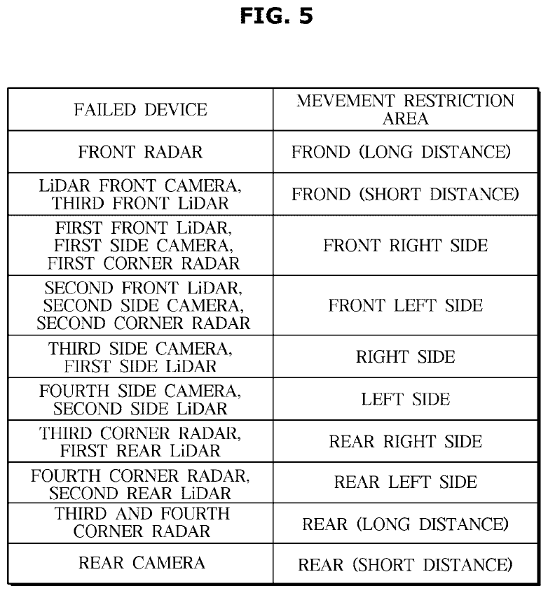

As shown in FIG. 5, the vehicle may store information about a movement restriction area in which movement of the vehicle is limited based on a failed device.

The vehicle may store strategy information for limiting at least one of pieces of control information for autonomous driving at the time of failure of each of the plurality of devices for obstacle recognition during autonomous driving control.

That is, the vehicle may store strategy information of autonomous driving corresponding to the failure of each device.

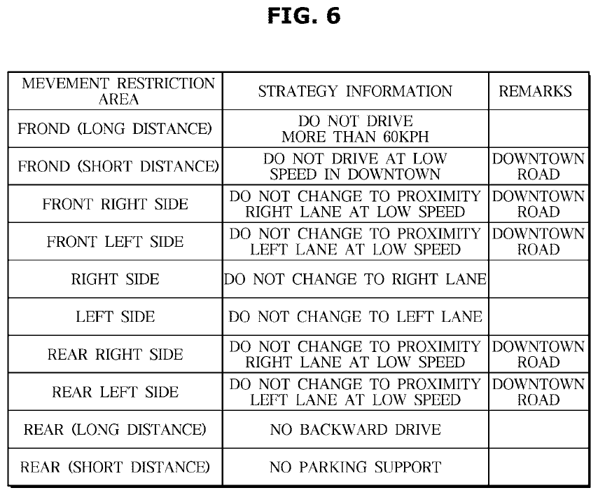

As illustrated in FIG. 6, the vehicle may store the movement restriction area, in which movement of the vehicle is limited due to a failure of at least one device, among the movable areas, and the strategy information corresponding to each movement restriction area.

The types of roads for which autonomous driving may be controlled based on the recognition area of each device may be different. The road types may be stored together with the strategy information corresponding to each movement restriction area.

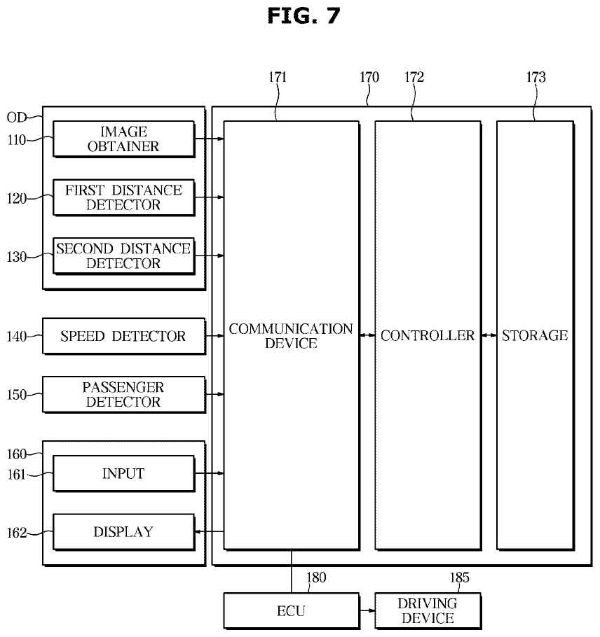

FIG. 7 is a control block diagram of a vehicle, a truck, according to an exemplary embodiment of the disclosure.

The vehicle includes a device OD, a speed detector 140, a passenger detector 150, a terminal 160, an autonomous drive control apparatus 170, an electronic control unit 180 (ECU), and a driving device 185.

The device OD detects an obstacle present on the road to recognize the obstacle and outputs obstacle information on the detected obstacle.

The device OD transmits the obstacle information to the autonomous drive control apparatus 170.

The device OD includes the image obtainer 110, the first distance detector 120, and the second distance detector 130. Here, the image obtainer 110, the first distance detector 120, and the second distance detector 130 are already described with reference to FIGS. 2 to 6, so the description of them will not be repeated below

The speed detector 140 detects driving speed of the vehicle and transmits the speed information on the detected driving speed to the autonomous drive control apparatus 170.

The speed detector 140 includes a plurality of wheel speed sensors that output detection information (that is, wheel speed information) corresponding to the rotational speed of front and rear left and right wheels 131 of the vehicle.

The speed detector 140 may include an acceleration sensor that outputs detection information (i.e., acceleration information) corresponding to acceleration of the vehicle.

The speed detector 140 may include both the plurality of wheel speed sensors and the acceleration sensor.

The vehicle may further include an illuminance detector to detect external illuminance, a temperature detector to detect outside air temperature, and a rain detector to detect whether it is raining and an amount of rain.

The passenger detector 150 detects a passenger of each seat and outputs the detected passenger information in order to recognize whether a passenger is present in the vehicle and the number of passengers.

The passenger detector 150 may be provided on at least one of the seat and a seat belt of the vehicle.

For example, the passenger detector 150 may include at least one of a weight detector, a pressure detector, a capacitance detector, and a detector of fastening of the seat belt.

The passenger detector 150 may also include a camera provided inside the vehicle.

The terminal 160 displays information on a function operating in the vehicle or a function operable in the vehicle, and displays information input by the user.

For example, when at least one of a navigation mode, a DMB mode, an audio mode, a video mode, a phone call mode, and a radio mode is selected, the terminal 160 performs a function for the at least one selected mode and displays operation information of the function being performed, and when the autonomous driving mode is selected, the terminal 160 may display map information matched with a route, and display front, rear, left, and right images of the vehicle.

The terminal 160 may include a display 162 and may further include an input 161.

When both the display 162 and the input 161 are provided in the terminal, the terminal may be a touch screen in which the input 161 and the display 162 are integrated.

When only the display 162 is provided in the terminal, the input 161 may be provided in the head unit or the center fascia of the vehicle, and may include at least one of a button, a switch, a key, a touch panel, a jog dial, a pedal, a keyboard, a mouse, a track-ball, various levers, handles, or sticks.

In this embodiment, it is assumed that the terminal 160 includes both the input 161 and the display 162.

The input 161 of the terminal 160 receives an operation command of the navigation mode, and receives information about a destination when the navigation mode is performed.

The input 161 may receive information about a selection of a plurality of routes searched from the current position to the destination.

The input 161 may receive information on the number of passengers.

The input 161 receives one of a manual driving mode in which the driver drives the vehicle on his/her own and the autonomous driving mode in which the driver lets the vehicle automatically drive, and transmits the received input to the autonomous drive control apparatus 170. The input 161 may receive information on a destination in the autonomous driving mode, receive a selection of highway driving, local road driving, or the like, or receive a driving speed.

The input 161 may receive information about whether a passenger will get off, and further receive information on stops at which the passengers will get off.

The display 162 displays a driving mode of the vehicle.

The display 162 may display failure information of at least one device for obstacle recognition, and display the strategy information of the autonomous driving when the at least one device fails.

The display 162 displays a map matched with a route to the destination when the navigation mode is performed.

When there is a plurality of routes to the destination, the display 162 may display a travel time and a travel distance corresponding to each route.

The display 162 may display information about a destination for repair of the failed device when the device fails.

The display 162 may display information for asking whether the passenger will get off when the device fails.

The display 162 may display information requesting input of a stop at which the passenger gets off, and may display a map matched with a route changed with the stop, or when the passenger will not get off, display a map that matches a route to a destination for repairing the failed device.

The autonomous drive control apparatus 170 automatically recognizes a road environment, determines a driving situation, and controls driving of the vehicle to the destination along the planned route.

The autonomous drive control apparatus 170 recognizes obstacles and lanes in the autonomous driving mode and controls driving of the vehicle while avoiding obstacles based on information about the recognized obstacles and lanes.

The autonomous drive control apparatus 170 includes a communication device 171, a controller 172 that controls autonomous driving, and a storage 173 that stores the strategy information corresponding to information about a failure of the device.

The communication device 171 communicates with various devices equipped in the vehicle.

Here, the various devices provided in the vehicle may be ones related to autonomous driving.

For example, the communication device 171 communicates with a plurality of devices for obstacle recognition, and communicates with the speed detector, the passenger detector, and the terminal.

The communication device 171 may perform communication between devices in the vehicle.

The communication device 171 may perform CAN communication, USB communication, Wi-Fi communication, and Bluetooth communication, and may further perform broadcasting communication such as TPEG, SXM, RDS and DMB, and 2G, 3G, 4G, and 5G communication.

The communication device 171 may include one or more components configured to allow communication with external devices, and for example, include at least one of a short-range communication module, a wired communication module, and a wireless communication module.

The external device may be a device provided in a service center, such as a terminal or a server.

The short-range communication module may include a variety of short-range communication modules, which are configured to transmit and receive signals using a wireless communication network in a short range, e.g., a Bluetooth module, an Infrared communication module, a Radio Frequency Identification (RFID) communication module, a Wireless Local Access Network (WLAN) communication module, an Near Field Communication (NFC) module, and a ZigBee communication module.

The wired communication module may include a variety of wired communication modules, e.g., Controller Area Network (CAN) communication module, Local Area Network (LAN) module, Wide Area Network (WAN) module, and Value Added Network (VAN) module or a variety of cable communication modules, e.g., Universal Serial Bus (USB), High Definition Multimedia Interface (HDMI), Digital Visual Interface (DVI), recommended standard 232 (RS-232), and plain old telephone service (POTS).

The wireless communication module may include a wireless communication module supporting a variety of wireless communication methods, e.g., Radio Data System-Traffic Message Channel (RDS-TMC), Digital Multimedia Broadcasting (DMB), Wi-Fi module, Wireless broadband module, Global System for Mobile (GSM) Communication, Code Division Multiple Access (CDMA), Wideband Code Division Multiple Access (WCDMA), Time Division Multiple Access (TDMA), and Long Term Evolution (LTE).

The communication device 171 includes a Global Positioning System (GPS) receiver (or a position receiver) 171a that communicates with a plurality of satellites and recognizes a current position of the vehicle based on information provided from the plurality of satellites.

That is, the position receiver 171a receives a signal from the satellite, recognizes the current position of the vehicle, and transmits current position information about the recognized current position to the controller 172.

When the navigation mode is selected, the controller 172 identifies the current position information received by the position receiver 171a and controls the display 162 to display a map within a predetermined range from the current position based on the identified current position information.

When destination information is input after the navigation mode is selected, the controller 172 searches for a route from the current position to the destination based on the input destination information and the current position information received by the position receiver 171a, and controls display 162 to display a map matched with the route.

When a plurality of routes is searched, the controller 172 controls the display to display the plurality of routes, and the travel time and the travel distance for each route, and when a route is selected through the input 161, controls display 162 to display a map matched with the selected route.

The controller 172 identifies the current position in real time while driving, and outputs road guide information through the display and a sound output unit (not shown) while displaying the current position identified in real time on the map displayed on the display.

When the manual driving mode is input, the controller 172 passes the control authority over to a controller for the manual driving mode provided in the vehicle.

In the manual driving mode, it is also possible for the controller 172 to control driving based on operation information such as the brake pedal, the accelerator pedal, a gearshift lever, and the steering wheel.

When the autonomous driving mode is input, the controller 172 may control the autonomous driving based on input information of the input 161, image information of the image obtainer 110, distance information of obstacles of the first and second distance detectors 120 and 130, driving speed information of the speed detector 160, and the current position information of the position receiver 171a.

When the autonomous driving mode is input, the controller 172 may search for a route to the destination based on illuminance, temperature, whether it is raining, and amount of rain.

The controller 172 controls acceleration and deceleration of the vehicle such that the driving speed of the vehicle follows a predetermined target driving speed or a target driving speed set by the user during the autonomous driving mode.

When an image is received from the image obtainer during the autonomous driving mode, the controller 172 recognizes lines of the road by performing image processing on the received image, recognizes a lane based on position information of the recognized lines, and controls the autonomous driving along the lane.

The controller 172 recognizes at least one of a position of an obstacle and a moving speed of the obstacle based on obstacle information detected by the image obtainer, and the first and the second distance detectors, and determines a movable area based on the recognized position of the obstacle, controls movement to the determined movable area, and controls driving speed based on the recognized position of the obstacle and the movement speed of the obstacle.

The position of the obstacle may include a direction of the obstacle and a distance from the vehicle to the obstacle.

The controller 172 may obtain driving speed of the vehicle based on detection information output from the plurality of wheel speed sensors.

The controller 172 may obtain driving speed of the vehicle based on detection information output from the acceleration sensor.

The controller 172 may obtain driving speed of the vehicle based on both the detection information output from the plurality of wheel speed sensors and the detection information output from the acceleration sensor

The controller 172 may obtain driving speed based on information about a change in current position provided from the position receiver.

The controller 172 may control operation of the display 162 of the terminal to display the position information of an obstacle in the navigation mode or the autonomous driving mode.

The controller 172 may display an image of the front, rear, left, or right direction of the vehicle obtained from the image obtainer 110.

When performing the autonomous driving mode, the controller 172 diagnoses failures in the plurality of devices for obstacle recognition, and when it is determined that there is a device in which a failure occurs, the controller 172 identifies a recognition area of obstacles recognized by the device and restricts the movement of the vehicle to the identified recognition area.

When identifying the recognition area of the obstacle recognized by the failed device, it is also possible for the controller 172 to identify a movement restriction area of the vehicle corresponding to the identified recognition area and restrict movement of the vehicle to the identified movement restriction area.

The controller 172 may identify the strategy information corresponding to the identified movement restriction area and control autonomous driving based on the identified strategy information.

While performing the autonomous driving mode, the controller 172 may identify the strategy information corresponding to the failed device and control the autonomous driving based on the identified strategy information.

The controller 172 may control the display 162 to display information about at least one device diagnosed as having a fault and corresponding strategy information.

When the controller 172 determines that the failure of at least one device has occurred, the controller 172 searches for a service center for repairing the at least one failed device based on the current position information, sets the position of the searched service center as a new destination, searches for a route based on the set destination information and the current position information, and controls the autonomous driving to the new destination based on route information on the searched route.

When the service center is searched, the controller 172 may control the communication device 171 to transmit information about appointment for a repair service to a server (not shown) or a terminal (not shown) of the searched service center.

In this case, the information about appointment for a repair service may include information of a failed device, arrival time to the service center, information of the vehicle, and the like.

When repair approval information is received from one of the plurality of service centers, the controller 172 may set the service center that transmitted the approval information as the final destination.

When the service center is determined, it is also possible for the controller 172 to control the display 162 to display information on the determined service center.

The controller 172 may receive passenger-presence and passenger-get-off-information through the communication device. The passenger-get-off information may include whether the passenger will get off and a stop at which the passenger will get. The controller 172 may obtain information about the stop based on the passenger-get-off information.

When it is determined that the at least one device has failed, the controller 172 identifies the passenger, and when the passenger exists apart from the driver, controls information asking whether the passenger will get off to be output. When information approving getting off is received through the input 161, the controller 172 controls information asking to enter a stop to be output, and when the stop information is received through the input 161, searches for a service center for repairing the failed device based on the stop information, the current position information, and original destination information, sets the searched service center as a new destination, searches for a route based on the information about the set destination, the stop, the original destination and the current position, and controls the autonomous driving to the destination based on information about the searched route.

The controller 172 may determine whether the strategy information corresponding to the at least one failed device indicates a change to the manual driving mode, and when it is determined that the strategy information corresponding to the failed device does not indicate a change to the manual driving mode, control information asking whether the driver will get off to be output, and also control information requesting input of a stop where the driver will get off to be output.

When receiving information rejecting getting off through the input 161, the controller 172 searches for a service center for repair of the failed device based on information about the current position and the original destination, sets the searched service center as a new destination, searches for a route based on the information about the new destination, the original destination, and the current position, and controls the autonomous driving to the new destination based on information about the searched route.

When it is determined that the stop is closer than the service center from the current position, the controller 172 controls the autonomous driving to the stop and then controls the autonomous driving to the service center.

When it is determined that the stop is farther than the service center from the current position, the controller 172 may control autonomous driving from the current position to the service center.

When it is determined that the stop is farther than the service center from the current position, the controller 172 determines a distance between the stop and the service center, and when the distance is less than a predetermined distance, controls the autonomous driving to the service center after controlling the autonomous driving to a waypoint.

The controller 172 checks information on a current road based on the current position information, and when it is determined from the information that the type of the current road is a city road, diagnoses a failure in devices necessary for autonomous driving control in the city road. When determining that at least one device has failed, the controller 172 may restrict autonomous driving on the city road.

Restricting autonomous driving on city road includes restricting lane changes, and passing over the control authority to the driver to change the lane manually.

Restricting autonomous driving on the city road includes changing to the manual driving mode.

The devices necessary for autonomous driving control on the city road may include the front camera, the third front LiDAR, the first and second front LiDAR, the first and second side cameras, the first, second, third and four corner radars, and the first and second rear LiDARs.

When it is determined from the information about the current road that the type of the current road is an expressway road, and the failed device is at least one of the front radar, the third and fourth side cameras, and the first and second side LiDARs, the controller 172 may restrict autonomous driving on the expressway road.

For example, when it is determined from the information about the current road that the type of the current road is an expressway road, and the failed device is the front radar, the controller 172 may control the driving speed of the vehicle to be less than or equal to a predetermined driving speed. When it is determined from the information about the current road that the type of the current road is an expressway road, and the failed device is at least one of the third side camera and the first side LiDAR, the controller 172 may restrict a change into a right lane from the current lane of the vehicle. When it is determined from the information about the current road that the type of the current road is an expressway road, and the failed device is at least one of the fourth side camera and the second side LiDAR, the controller 172 may restrict a change into a left lane from the current lane of the vehicle.

The predetermined driving speed may be approximately 60 kph.

When it is determined from the information about the current road that the road type is the expressway road, and the failed device is at least one of the devices that recognize an obstacle in a front short-range area, the controller 172 may restrict low-speed driving. When it is determines from the information about the current road that the road type is the expressway road, and the failed device is at least one of the devices that recognize an obstacle in the front left side area, the front right side area, the rear left side area, and the rear right side area, the controller 172 may restrict lane changes.

The low speed may be the speed below a predetermined driving speed.

When it is determined that the failed device is a device for recognizing obstacles in the rear short distance area and the rear long distance area, the controller 172 controls the autonomous driving mode to be maintained to the service center.

When it is determined that the failed device is a device for recognizing an obstacle in at least one of the front long distance area, the left side area, and the right side area, the controller 172 obtains road information based on information about the current position, and when it is determined from the road information that the type of the road is the expressway road, maintains the autonomous driving mode but performs restriction control for the high speed road.

The restriction control for the expressway road may include driving speed restriction and lane change restriction.

When it is determined that the failed device is a device for recognizing an obstacle in one of the front left side area, the front right side area, the rear left side area, and the rear right side area, the controller 172 obtains road information based on information about the current position, and when it is determined from the road information that the type of the road is a city road, maintains the autonomous driving mode but passes over control authority for lane change to the driver. For example, the controller 172 may control the display to display control authority takeover information for lane change so that the driver may makes lane changes without autonomous control over the lane change.

In this case, the vehicle may change lanes based on information about the steering wheel manipulated by the driver.

When the failed device is a device for recognizing an obstacle in one of the front long distance area or the front short distance area, the controller 172 changes the autonomous driving mode to the manual driving mode, and passes over a control authority of braking, acceleration, deceleration, and steering of the vehicle to the driver. For example, the controller 172 may control the display to display the control authority takeover information for the manual driving mode.

When the failed device is a device for recognizing an obstacle in the front short distance area, the controller 172 may obtain road information based on information about the current position, and when it is determined from the road information that the type of the road is the city road, change the autonomous driving mode to the manual driving mode

When there is a plurality of devices for recognizing obstacles in one of the movable areas of the vehicle, the controller 172 may perform autonomous driving based on information about an obstacle recognized by other devices than the failed device in the autonomous driving control.

For example, when it is determined that the third side camera has a failure, the controller 172 detects an obstacle in the right side area using the first side LiDAR and controls movement to the right side area based on information on the detected obstacle.

When there is a plurality of devices for recognizing obstacles in one of the movable areas of the vehicle and some of the devices have a failure in the autonomous driving control, the controller 172 may control the autonomous driving based on strategy information.

For example, when it is determined that the third side camera has a failure, the controller 172 may identify the strategy information corresponding to the right side area and control autonomous driving based on the identified strategy information (e.g., indicating no change to the right lane).

When there is a plurality of devices for recognizing obstacles in one of the movable areas of the vehicle, and all the plurality of devices have a failure, the controller 172 may control the autonomous driving based on the strategy information

For example, when it is determined that the third side camera and the first side LiDAR have failed, the controller 172 may identify the strategy information corresponding to the right side area and control the autonomous driving based on the identified strategy information (e.g., indicating no change to the right lane).

The controller 172 may be a controller provided in the vehicle.

The controller 172 of the apparatus 170 according to an exemplary embodiment of the present disclosure may be a processor (e.g., computer, microprocessor, CPU, ASIC, circuitry, logic circuits, etc.). The controller 172 may be implemented by a non-transitory memory storing, e.g., a program(s), software instructions reproducing algorithms, etc., which, when executed, controls operations of various components of the vehicle 1, and a processor configured to execute the program(s), software instructions reproducing algorithms, etc. Herein, the memory and the processor may be implemented as separate semiconductor circuits (e.g., chips). Alternatively, the memory and the processor may be implemented as a single integrated semiconductor circuit. The processor may embody one or more processor(s).

The storage 173 may store the map information.

The storage 173 may store the position information of the service center.

The storage 173 may store a program to perform the autonomous driving mode and a program to perform the navigation mode.

The storage 173 may store information about the movement restriction area for each device for obstacle recognition having a failure where movement of the vehicle is restricted.

The storage 173 may store a recognition area for each device for obstacle recognition.

The movement restriction area of the vehicle for each device may be determined based on the recognition area for the device.

The storage 173 may store the strategy information of the control information for controlling autonomous driving for each movement restriction area of the vehicle.

The storage 173 may store the strategy information of the control information for controlling autonomous driving when a failure occurs for each device for obstacle recognition.

The storage 173 may be a memory that is implemented as a separate chip from the processor as described above in relation to the controller 172, or may be implemented with a processor in a single chip.

The storage 173 may be implemented using at least one of a non-volatile memory element, e.g., a cache, Read Only Memory (ROM), Programmable ROM (PROM), Erasable Programmable ROM (EPROM), Electrically Erasable Programmable ROM (EEPROM) and flash memory; a volatile memory element, e.g., Random Access Memory (RAM); or a storage medium, e.g., Hard Disk Drive (HDD) and CD-ROM. The implementation of the memory is not limited thereto.

The vehicle 1 includes an electronic control unit (ECU) 180 which controls operations of the driving device, various safety devices and various detection devices.

Here, the ECU 180 may be provided for each device, or may be provided as one to comprehensively control the plurality of electronic devices.

The driving device 185 may be a device for applying driving force and braking force to the front, rear, left, and right wheels, such as the power generating apparatus, the power transfer apparatus, the steering apparatus, the braking apparatus, the suspension apparatus, and the transmission apparatus, a fuel device, and the like.

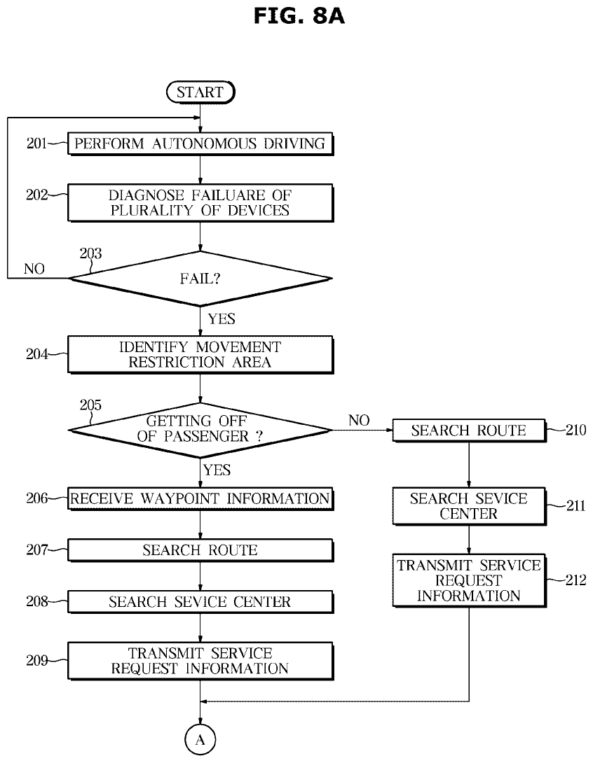

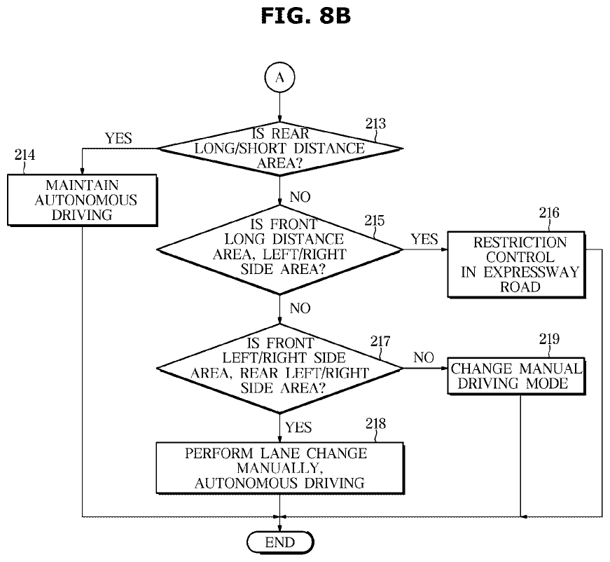

FIGS. 8A and 8B are a flowchart illustrating an example of a control method of a vehicle, according to an exemplary embodiment of the disclosure.

When the autonomous driving mode is selected, the vehicle determines a current position, determines a destination input through the input 161, searches for a route from the current position to the destination based on the destination information and the current position information, matches the route to a map and displays the map matched with the route through the display.

The vehicle may automatically activate the navigation mode when the autonomous driving mode is selected.

When an image is received from the image obtainer 110 during autonomous driving, the vehicle performs image processing on the received image to recognize lines on the road, recognizes a lane based on information about positions of the recognized lines, and controls the autonomous driving along the recognized lane.

The vehicle recognizes the presence of an obstacle and the position of the obstacle in the image obtained from the image obtainer 110 during the autonomous driving, recognizes at least one of the moving speed of the obstacle and the position of the obstacle based on the obstacle information detected by the first and second distance detectors 120 and 130, determines a movable area based on the recognized position of the obstacle, and moves to the determined movable area.

The vehicle autonomously drives while performing at least one of acceleration and deceleration of the vehicle such that the driving speed of the vehicle follows a predetermined target driving speed or a target driving speed set by the user.

The vehicle diagnoses a failure in the plurality of devices 110, 120, and 130 for obstacle recognition (202) during the autonomous driving (201), and when it is determined that the at least one device fails (203), identifies a movement restriction area of the vehicle corresponding to the at least one failed device (204).

The vehicle may identify a recognition area of obstacles recognized by the at least one device having a failure, and also identify a movement restriction area of the vehicle corresponding to the identified recognition area.

When it is determined that the at least one device has failed, the vehicle determines the existence of a passenger, and when it is determined that there is a passenger apart from the driver, the vehicle outputs information asking whether the passenger will get off.

The information asking whether the passenger will get off may be output through at least one of the display and the sound output unit (not shown).

When it is determined that there is the passenger apart from the driver, the vehicle may automatically search for a stop where the passenger will get off and output information asking whether the passenger will get off at the stop. For example, the stop at which the passenger will get off might be a place where public transportation is available.

When it is determined that there is a passenger apart from the driver, it is also possible for the vehicle to automatically set the stop where the passenger will get off.

The vehicle determines whether the passenger will get off based on reception of approval of getting off. (205). Here, the received approval of getting off may be input through the input 161.

When it is determined that the passenger is getting off, the vehicle outputs information requesting input of a stop, and, when information about a stop is received through the input 161 (206), searches for a route based on the information about the stop, the current position and the destination (207), searches for a plurality of service centers located adjacent to the route based on the route information (208), determines based on position information of the plurality of service centers a service center among the plurality of service centers around the route, which starts from the current position and passes the stop and sends a service request to the service center (209).

Searching for the service center includes searching for a service center that may give a quick repair service for the failed device.

When it is determined that there is no service center along the route that starts from the current position and passes the stop, the vehicle finds one of the service centers near the route, which is located nearest to the stop, and transmits a service request to the service center.

The vehicle may search a service center for repair of the failed device based on information about the stop, the current position, and the original destination, and search for a route based on the information about the position of the searched service center (i.e., a new destination), the stop, the original destination and the current position.

When it is determined that the passenger is not getting off based on reception of rejection of getting off through the input 161, the vehicle searches for a route based on information about the current position and the original destination.

In this case, the searched route may be the same as the original route.

The vehicle searches for a plurality of service centers positioned adjacent to the route based on the route information (211), determines position information of each of the plurality of service centers, and determines a service center positioned in the route between the current position and the destination based on the position information of the plurality of service centers, and transmits a service request to the service center (212).

When it is determined that there is no service center positioned in the route between the current position and the destination, the vehicle may determine one of the service centers positioned adjacent to the route between the current position and the destination, which is closest to the current position, and transmit a service request to the service center.

The vehicle determines whether the movement restriction area corresponding to the failed device is the rear short distance area and the rear long distance area (213), and when it is determined that the movement restriction area is at least one of the rear short distance area and the rear long distance area, maintains the autonomous driving to the service center (214).

The determining of whether the movement restriction area is a rear short distance area includes determining a failure of the rear camera.

The determining of whether the movement restriction area is the rear long distance area includes determining a failure of at least one of the third and fourth corner radars.

The determining that the movement restriction area is the rear long distance area may include determining that a backward movement is impossible.

When it is determined that the movement restriction area corresponding to the failed device is not the rear short distance area and the rear long distance area, the vehicle determines whether the movement restriction area is at least one of the front long distance area, the left side area, and the right side area (215). When it is determined that the movement restriction area is at least one of the front long distance area, the left side area and the right side area, the vehicle restricts at least one of driving speed and lane change, and drives to the service center in the autonomous driving mode.

When the movement restriction area is the front long distance area, the vehicle performs autonomous driving by restricting the driving speed of the vehicle to be less than or equal to a predetermined driving speed.

The determining of whether the movement restriction area is the front long distance area includes determining a failure of the front radar.

When it is determined that the movement restriction area is the left side area, the vehicle restricts a change to the left lane and controls autonomous driving. When it is determined that the movement restriction area is the right side area, the vehicle restricts a change to the right lane and controls autonomous driving.

The determining that the movement restriction area is the left side area includes determining at least one failure of the fourth side camera and the second side LiDAR.

The determining that the movement limitation area is the right side area includes determining a failure of at least one of the third side camera and the first side LiDAR.

When it is determined that the movement restriction area corresponding to the failed device is not the rear short distance area and the rear long distance area but at least one of the front long distance area, the left side area, and the right side area, the vehicle obtains road information based on the current position information, and when it is determined from the road information that the type of the road is the expressway road, maintains the autonomous driving mode but performs restriction control for the expressway.

The restriction control for the expressway may include driving speed restriction and lane change restriction.

When it is determined that the movement limitation area corresponding to the failed device is not at least one of the front long distance area, the left side area and the right side area, the vehicle determines whether the movement restriction area corresponding to the failed device is at least one of the front left side area and the front right side area, the rear left side area, and the rear right side area (217).

The determining of whether the movement restriction area is the front left side area includes determining a failure of at least one of the second front side LiDAR, the second side camera, and the second corner radar.

The determining of whether the movement restriction area is the front right side area includes determining a failure of at least one of the first front side LiDAR, the first side camera, and the first corner radar.

The determining of whether the movement restriction area is the rear left side area includes determining a failure of at least one of the fourth corner radar and the second rear LiDAR.

The determining of whether the movement restriction area is the rear right side area includes determining a failure of at least one of the third corner radar and the first rear LiDAR.

When it is determined that the movement restriction area is at least one of the front left side area, the front right side area, the rear left side area, and the rear right side area, the vehicle controls forward and the backward movements by autonomous driving, and controls lane changes manually (218).

At this time, the vehicle passes over control authority of a change of lane to the user.

In other words, the lane change is performed not automatically but manually based on information about the steering wheel manipulated by the user.

At this time, the vehicle outputs information about takeover of the lane change of the vehicle through the display or the sound output unit.

When it is determined that the movement restriction area is at least one of the front left side area, the front right side area, the rear left side area, and the rear right side area, the vehicle obtains road information based on the current position information, and when it is determined from the road information that the type of the road is a city road, controls autonomous driving and passes over the control authority of the lane change to the driver.

In other words, the vehicle does not autonomously control the lane change on the city road, but performs the lane change manually by the driver.

When it is determined that the movement restriction area is not at least one of the front left side area, the front right side area, the rear left side area and the rear right side area, the vehicle determines that the movement restriction area is the front area, and changes the autonomous driving mode to the manual driving mode (219).

At this time, the vehicle passes over the control authority of driving, braking, acceleration, deceleration, and steering of the vehicle to the driver, and displays the takeover information for control authority for the manual driving mode on the display. When it is determined that the movement restriction area is the front area, the vehicle may output an instruction to stop driving.

When it is determined that the movement restriction area is the front short distance area, the vehicle may obtain the road information based on the current position information, when it is determined from the road information that the type of the road is a city road, change the autonomous driving mode to the manual driving mode.

As is apparent from the above description, a vehicle according to exemplary embodiments of the disclosure may store strategy information for autonomous driving control corresponding to a recognition area of a failed device during the autonomous driving control. Accordingly, the vehicle may secure stability and reliability in autonomous driving by limiting and controlling the autonomous driving based on the strategy information corresponding to the failed device.

Hence, the vehicle according to exemplary embodiments of the disclosure may prevent a collision with another vehicle or obstacle by limiting autonomous driving based on the movement restriction area and the strategy information of the vehicle corresponding to the recognition area of the failed device.

In addition, according to exemplary embodiments of the disclosure, a vehicle may avoid accident risks in advance by passing over the driving control authority of the vehicle to the user based on the recognition area of the failed device.

According to exemplary embodiments of the disclosure, a vehicle may easily drive to a service center, have a convenient and quick repair service for a failed device by searching for the service center to fix the failed device based on information about a current position, a destination and a stop, transmitting information about appointment for the repair service to the searched service center, and maintains autonomous driving to the searched service center.

According to exemplary embodiments of the disclosure, a vehicle may stably perform autonomous driving by controlling autonomous driving based on the movement restriction area of the vehicle corresponding to a failed device and a road type.

According to exemplary embodiments of the disclosure, the quality and marketability of the autonomous drive control apparatus and the vehicle may be improved, and convenience of the user and product competitiveness may be secured.

Meanwhile, some embodiments of the disclosure may be embodied in the form of a recording medium storing instructions executable by a computer. The instructions may be stored in the form of a program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored. For example, there may be a ROM, a RAM, a magnetic tape, a magnetic disk, a flash memory, and an optical data storage device.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. An autonomous drive control apparatus comprising:
a communication device configured to perform communication with an external device and a plurality of devices for obstacle recognition, and to receive current position information;
a storage storing strategy information corresponding to a failure of each of the plurality of devices; and
a controller configured to:
diagnose a failure of the plurality of devices during autonomous driving,
when at least one device among the plurality of devices fails, identify the strategy information corresponding to the at least one device stored in the storage, and
perform restriction control on at least one of a driving speed, a lane change, or a backward movement of the autonomous driving based on the identified strategy information.

2. The autonomous drive control apparatus according to claim 1, wherein the controller is configured to search for a service center for repairing the at least one device based on the current position information received through the communication device, to control the autonomous driving to the service center as a destination, and to transmit a service request to the service center.

3. The autonomous drive control apparatus according to claim 2, wherein, when searching for the service center, the controller is configured to obtain route information based on reception of information about getting-off of a person on board through the communication device, and to search for the service center based on the route information.

4. The autonomous drive control apparatus according to claim 1, wherein the storage further stores information about a movement restriction area of a vehicle corresponding to the failure of each of the plurality of devices.

5. The autonomous drive control apparatus according to claim 4, wherein the controller is configured to change a driving mode to a manual driving mode when the movement restriction area corresponding to the at least one device is at least one of a front long distance area or a front short distance area of the vehicle.

6. The autonomous drive control apparatus according to claim 4, wherein the controller is configured to determine whether a type of a road is an expressway based on the received current position information, and
wherein, when the type of the road is the expressway and when the movement restriction area corresponding to the at least one device is at least one of a front long distance area, a right side area, or a left side area, the controller restricts the driving speed or the lane change.

7. The autonomous drive control apparatus according to claim 6, wherein:
when the movement restriction area corresponding to the at least one device is the front long distance area, the controller restricts the driving speed, and
when the movement restriction area corresponding to the at least one device is at least one of the right side area or the left side area, the controller restricts the lane change.

8. The autonomous drive control apparatus according to claim 4, wherein the controller is configured to determine whether a type of a road is a city road based on the received current position information, and
wherein, when the type of the road is the city road and when the movement restricting region corresponding to the at least one device is at least one of a front left side area, a front right side area, a rear left side area, or a rear right side area, the controller controls autonomous driving for a forward and backward movement, and controls the lane change based on manipulation information of a steering wheel received from a user.

9. A vehicle comprising:
a communication device configured to receive current position information;
a plurality of devices for recognizing an obstacle;
a storage for storing strategy information corresponding to a failure of each of the plurality of devices; and
an autonomous drive control apparatus configured to:
diagnose a failure of the plurality of devices during autonomous driving,
when at least one device among the plurality of devices fails, identify the strategy information corresponding to the at least one device stored in the storage, and
perform restriction control on at least one of a driving speed, a lane change, or a backward movement of the autonomous driving based on the identified strategy information,
wherein the plurality of devices includes a plurality of image obtainers, a first distance detector including a plurality of radars, and a second distance detector including a plurality of LiDARs.

10. The vehicle according to claim 9, wherein the autonomous drive control apparatus is configured to search for a service center for repairing the at least one device based on the received current position information, to control the autonomous driving to the searched service center as a destination, and to transmit a service request to the service center.

11. The vehicle according to claim 10, further comprising an input for receiving information about whether a person on board will get off,
wherein, when searching for the service center, the autonomous drive control apparatus is configured to obtain route information based on the information about whether a person on board will get off received through the input, and to search for a service center based on the route information.

12. The vehicle according to claim 9,
wherein the storage further stores information about a movement restriction area of the vehicle corresponding to the failure of each of the plurality of devices.
wherein the movement restriction area includes a front long distance area, a front short distance area, a front right side area, a front left side area, a right side area, a left side area, a rear right side area, a rear left side area, a rear long distance area, and a rear short distance area.

13. The vehicle according to claim 12, wherein the autonomous drive control apparatus is configured to change a driving mode to a manual driving mode when the movement restriction area corresponding to the at least one device is at least one of the front long distance area or the front short distance area of the vehicle,

14. The vehicle according to claim 12, wherein the autonomous drive control apparatus determines whether a type of a road is an expressway based on the received current position information, and
when the type of the road is the expressway and when the movement restriction area corresponding to the at least one device is at least one of the front long distance area, the right side area, or the left side area, the autonomous drive control apparatus restricts the driving speed or the lane change.

15. The vehicle according to claim 14, wherein:
when the movement restriction area corresponding to the at least one device is the front long distance area, the autonomous drive control apparatus restricts the driving speed, and
when the movement restriction area corresponding to the at least one device is at least one of the right side area or the left side area, the autonomous drive control apparatus restricts the lane change.

16. The vehicle according to claim 9, wherein the autonomous drive control apparatus is configured to determine whether a type of a road is a city road based on the received current position information, and
wherein, when the type of the road is the city road and when the movement restriction area corresponding to the at least one device is at least one of the front left side area, the front right side area, the rear left side area, or the rear right side area, the autonomous drive control apparatus controls autonomous driving for a forward and backward movement, and controls the lane change based on manipulation information of a steering wheel received from a user.

17. The vehicle according to claim 9, further comprising a display for displaying information corresponding to the restriction control.

18. A control method of a vehicle, the control method comprising:
searching for a route based on current position information received by a communication device and destination information input through an input,
performing autonomous driving based on the route,
diagnosing a failure of a plurality of devices to recognize an obstacle during the autonomous driving,
identifying strategy information corresponding to at least one device among the plurality of devices determined to have a failure, and
controlling at least one of a driving speed, a lane change, or a backward movement of the autonomous driving based on the strategy information.

19. The control method according to claim 18, further comprising:
searching for a service center for repairing the at least one device based on the current position information and the route, and
transmitting a service request to the service center.

20. The control method according to claim 18, wherein the searching for a service center comprises:
when information about getting-off of a person on board is received, obtaining route information based on the information about getting-off of the person on board, and
searching for the service center based on the route information.

21. The control method according to claim 18, further comprising:
changing a driving mode to a manual driving mode, when the strategy information corresponding to the at least one device indicates that driving at a speed higher than a first predetermined driving speed is prevented or that driving at a speed lower than a second predetermined driving speed is prevented.

22. The control method according to claim 18, further comprising:
determining whether a type of a road is an expressway based on the current position information, and
determining whether the strategy information corresponding to the at least one device indicates that driving at a speed higher than a first predetermined driving speed or that lane change is prevented, when the type of the road is the expressway.

23. The control method according to claim 18, further comprising:
determining whether a type of a road is a city road based on the current position information,
determining whether or not the strategy information corresponding to the at least one device indicates that lane change needs to be performed manually, when the type of the road is the city road.
